(19) United States
(12) Patent Application Publication
(10) Pub. No.: US 2016/0364354 A1
(43) Pub. Date: Dec. 15, 2016

(54) SYSTEM AND METHOD FOR COMMUNICATING WITH SERIALLY CONNECTED DEVICES

(71) Applicant: Solomon Systech (Shenzhen) Limited, Shenzhen (CN)

(72) Inventors: Feng Lin, Shenzhen (CN); Wing Chi Stephen Chan, Shenzhen (CN); Yu Zhang, Shenzhen (CN); Wai Kwong Lee, Shenzhen (CN)

(73) Assignee: SOLOMON SYSTECH (SHENZHEN) LIMITED

(21) Appl. No.: 14/742,725

(22) Filed: Jun. 18, 2015

(30) Foreign Application Priority Data
Jun. 10, 2015 (CN) 201510317610.9

(51) Int. Cl. G06F 13/40; G06F 13/42

(52) U.S. Cl. CPC G06F 13/4022; G06F 13/42

(57) ABSTRACT

A system for communicating with a plurality of serially connected devices includes: a link master connected with one of the devices; a plurality of devices serially connected with one another, each device including: a first input port, a first output port, a switch connecting the first input port and the first output port, and a command decoder connected with the switch and configured to recognize different commands from the link master and close or open the switch accordingly; and an ID register configured to store the ID being assigned by a link master. The link master is configured to assign ID to each one of the devices in sequence, and to access any one of the devices directly for read or write by providing the assigned ID to all devices in parallel. A method for communicating with a plurality of serially connected devices is also provided.

### CROSS-REFERENCE TO RELATED APPLICATIONS

The present application claims the benefit of Chinese Patent Application No. 201510317610.9 filed on Jun. 10, 2015, the contents of which are hereby incorporated by reference.

### FIELD OF THE PATENT APPLICATION

The present patent application generally relates to communication technologies and more specifically to a system and a method for communicating with serially connected devices.

### BACKGROUND

In communication, it is often required to communicate with a number of serially connected devices from a controller. The serially connected devices may be ICs and the communication is implemented with a daisy chain protocol. In this protocol, the system is always unicasting in delivering data packets. Each serially connected device is configured to only accept a packet when a header number is zero. If the header number is non-zero for a particular device, the header number will be decremented by one and the packet will be passed to the following device. For such a system, as the number of devices increases, the data transfer latency will increase.

### SUMMARY

The present patent application is directed to a system for communicating with a plurality of serially connected devices. In one aspect, the system includes: a link master connected with one of the devices; a plurality of devices serially connected with one another, each device including: a first input port, a first output port, a switch connecting the first input port and the first output port, and a command decoder connected with the switch and configured to recognize different commands from the link master and close or open the switch accordingly; and an ID register configured to store the ID being assigned by a link master. The link master is configured to assign ID to each one of the devices in sequence, and to access any one of the devices directly for read or write by providing the assigned ID to all devices in parallel.

The link master may be configured to generate a sequence of ID assignment commands onto a communication link, and a first device among the devices may be configured to receive a first ID assignment command in the sequence from the communication link, store a first ID from the first ID assignment command into the ID register of the first device, close the switch of the first device, and pass additional ID assignment commands in the sequence to a next device serially connected to the first device.

The link master may be configured to generate an ID assignment command. All the devices may be configured to receive the ID assignment command. All the switches inside all the devices may be configured to open thereafter. The link master may be configured to generate a sequence of ID numbers. A first device among the devices may be configured to recognize a first ID number, store this first ID number in the sequence into the ID register of the first device, close the switch of the first device, and pass additional ID numbers in the sequence to a next device serially connected to the first device.

Each device may further include a voltage buffer connecting the switch and the first output port. Each device may further include a mixer or multiplexer connecting the switch and the voltage buffer.

Each device may further include a second output port, the second output port being connected with the command decoder and in communication with the link master though an upstream link.

Each device may further include a second input port, a second output port, a mixer connected with the second input port and the command decoder, and a voltage buffer connecting the mixer and the second output port. The first output port of a first device among the devices may be in communication with the first input port of a second device among the devices that is next to the first device, forming a downstream link, while the second output port of the second device may be in communication with the second input port of a first device among the devices that is next to the second device, forming an upstream link.

Each device may further include a protocol converter connected between the second input port and the mixer, the second output port of a first device among the devices may be connected with the link master, the second output ports of the other devices may be connected to an upstream link, while the upstream link may be connected to the second input port of the first device.

In another aspect, the present patent application provides a method for communicating with a plurality of serially connected devices. The method includes: assigning ID to each one of a plurality of devices one after another, each device including: a first input port, a first output port, and a switch connecting the first input port and the first output port; closing the switches of all the devices after assigning ID to the devices; and reading or writing an individual one of the devices directly through the closed switches by the ID assigned to that device without reading or writing any other one of the devices.

Each device may further include a command decoder connected with the switch and configured to recognize different commands from the link master and close or open the switch accordingly.

Each device may further include an ID register configured to store the ID being assigned by the link master. The method may further include a link master generating a sequence of ID assignment commands onto a communication link; and a first device receiving a first ID assignment command in the sequence from the communication link, storing a first ID from the first ID assignment command into the ID register of the first device, closing the switch of the first device, and passing additional ID assignment commands in the sequence to a next device serially connected to the first device.

The method may further include a link master generating an ID assignment command; all the devices receiving the ID assignment command; all the devices opening their switches thereafter; the link master generating a sequence of ID numbers; and a first device among the devices storing a first ID number in the sequence into the ID register of the first device, closing the switch of the first device, and passing additional ID numbers in the sequence to a next device serially connected to the first device.

Each device may further include a voltage buffer connecting the switch and the first output port. Each device may further include a mixer or multiplexer connecting the switch and the voltage buffer.

In yet another aspect, the present patent application provides a system for communicating with a plurality of serially connected devices. The system includes: a plurality of devices serially connected with one another and forming a chain, each device including: a first input port, a first output port, a switch connecting the first input port and the first output port, a voltage buffer connecting the switch and the first output port, and a mixer or multiplexer connecting the switch and the voltage buffer; and a link master connected with a first device and a last device in the chain. The link master is configured to sequentially assign ID to each one of the devices one after another, close the switches of all the devices, and then read or write an individual one of the devices directly through the closed switches by the ID assigned to that device without reading or writing any other one of the devices.

The first output port of the last device in the chain may be connected to the link master through an upstream link. Each device may further include a command decoder connected with the switch and configured to recognize different commands from the link master and close or open the switch accordingly. Each device may further include an ID register configured to store the ID being assigned by the link master.

### BRIEF DESCRIPTIONS OF THE DRAWINGS

FIG. 1 illustrates three operating states of a system for communicating with a plurality of serially connected devices in accordance with an embodiment of the present patent application.

FIG. 2 illustrates one of the serially connected device in the system depicted in FIG. 1.

FIG. 3 illustrates the process of device ID assignment for the system depicted in FIG. 1.

FIG. 4 illustrates a write process for the system depicted in FIG. 1.

FIG. 5 illustrates a read process for the system depicted in FIG. 1.

FIG. 6 is a timing diagram illustrating an ID assignment process for the system depicted in FIG. 1.

FIG. 7 illustrates a process flow of a method for communicating with a plurality of serially connected devices in accordance with the embodiment of FIG. 6.

FIG. 8 is a timing diagram illustrating an ID assignment process for a system in accordance with another embodiment of the present patent application.

FIG. 9 illustrates a process flow of a method for communicating with a plurality of serially connected devices in accordance with the embodiment of FIG. 8.

FIG. 10A illustrates a device that can be serially connected in a system in accordance with another embodiment of the present patent application.

FIG. 10B illustrates a device that can be serially connected in a system in accordance with another embodiment of the present patent application.

FIG. 10C illustrates a device that can be serially connected in a system in accordance with another embodiment of the present patent application.

FIG. 10D illustrates a device that can be serially connected in a system in accordance with another embodiment of the present patent application.

FIG. 10E illustrates a device that can be serially connected in a system in accordance with another embodiment of the present patent application.

FIG. 11 illustrates a system using the device depicted in FIG. 10A.

FIG. 12 illustrates a system using the device depicted in FIG. 10B.

FIG. 13 illustrates a system using the device depicted in FIG. 10C.

FIG. 14 illustrates a system using the device depicted in FIG. 10D.

FIG. 15 illustrates a system using the device depicted in FIG. 10E.

### DETAILED DESCRIPTION

Reference will now be made in detail to a preferred embodiment of the system and the method for communicating with serially connected devices disclosed in the present patent application, examples of which are also provided in the following description. Exemplary embodiments of the system and the method disclosed in the present patent application are described in detail, although it will be apparent to those skilled in the relevant art that some features that are not particularly important to an understanding of the system and the method may not be shown for the sake of clarity.

Furthermore, it should be understood that the system and the method disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

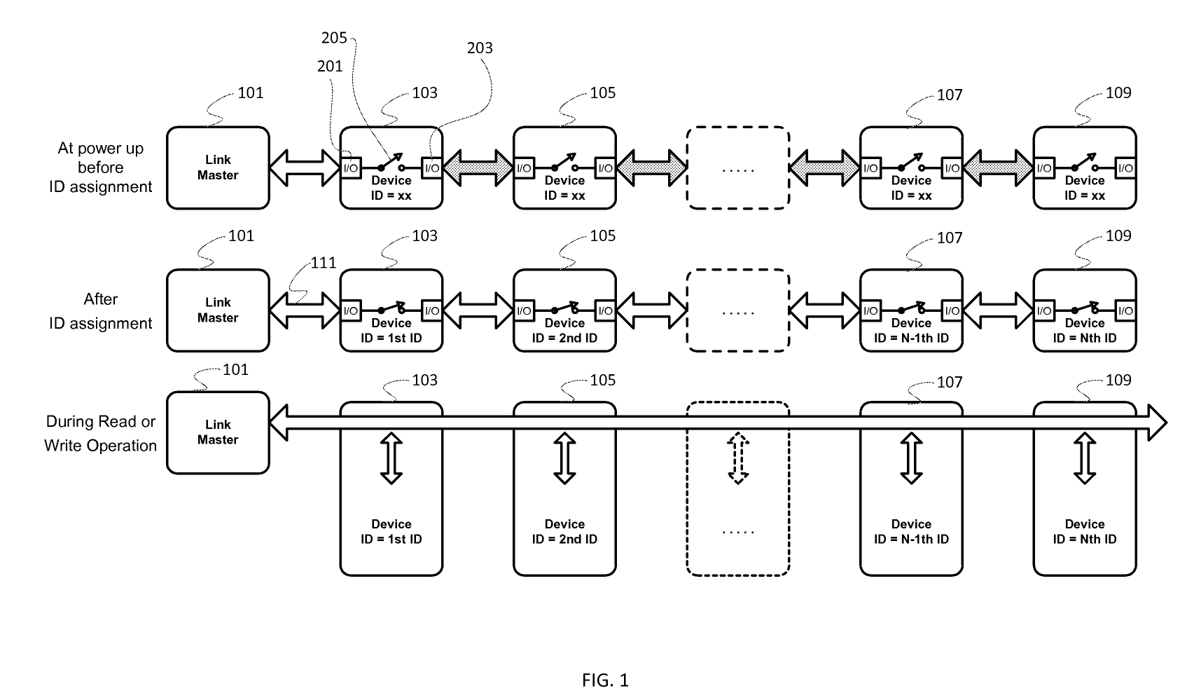

FIG. 1 illustrates three operating states of a system for communicating with a plurality of serially connected devices in accordance with an embodiment of the present patent application. Referring to FIG. 1, the system includes a link master 101, and a plurality of devices 103, 105, . . . , 107 and 109, connected with the link master 101 in series. The serially connected devices 103, 105, 107 and 109 are essentially identical devices.

Referring to FIG. 1, each serially connected device, for example device 103 includes a first I/O port 201, a second I/O port 203, and a switch 205 connecting the first I/O port 201 and the second I/O port 203. At system power-up, when no ID is assigned to any of the devices 103, 105, . . . , 107 and 109, the switch 205 of each device is turned off (open). The link master 101 is configured to assign ID to the devices one after another. After the devices are all assigned an ID, the switch 205 of each device is turned on (closed). It is noted that at this point, the closed switches 205 forms a shared bus for all the devices. During a read or write operation, the link master 101 is configured to read or write a particular device directly through the shared bus by the ID assigned to the device without reading or writing any of the other devices, and perform read or write operations to that device. In this embodiment, the link master 101 is a microcontroller and configured to generate required protocol signals. The bidirectional arrow 111 in FIG. 1 represents a communication link.

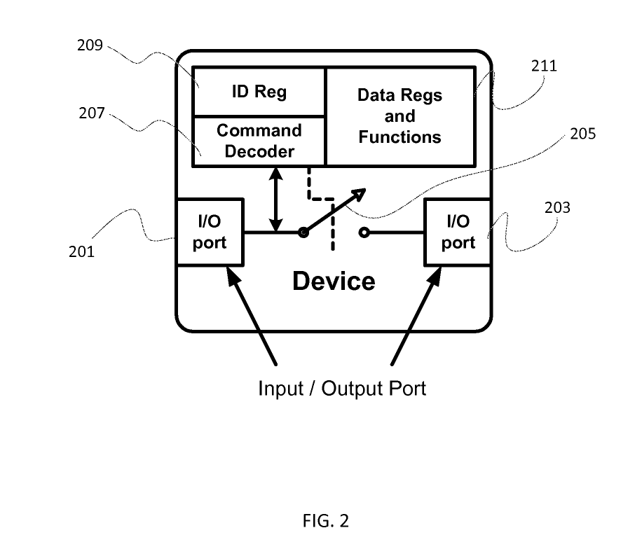

FIG. 2 illustrates one of the serially connected device in the system depicted in FIG. 1. Referring to FIG. 2, the device is equipped with at least two I/O ports 201 and 203. One of the two I/O ports may contain one or more physical connections or signals. For example, an I2C communication link has a serial DATA signal and a serial CLOCK signal. Among the two I/O ports, one port serves as an input port while the other port serves as an output port at any time instance. Hence, data/information can be transfer from either left to right (in a downstream direction) or right to left (in an upstream direction). The switch 205 is configured to connect or disconnect the two I/O ports.

In this embodiment, the device further includes a command decoder 207 connected with the switch 205 and configured for recognizing different commands (from the link master 101, for example) and acting accordingly. The actions include making or breaking the connection between the two I/O ports 201 and 203. The device further includes an ID register 209, which is configured to store the ID being assigned by the link master 101.

In this embodiment, the device may include other components, such as data registers 211, for storing parameters, computational capabilities, sensing the environment, driving a display, and etc. These components are collectively indicated as Functions in FIG. 2.

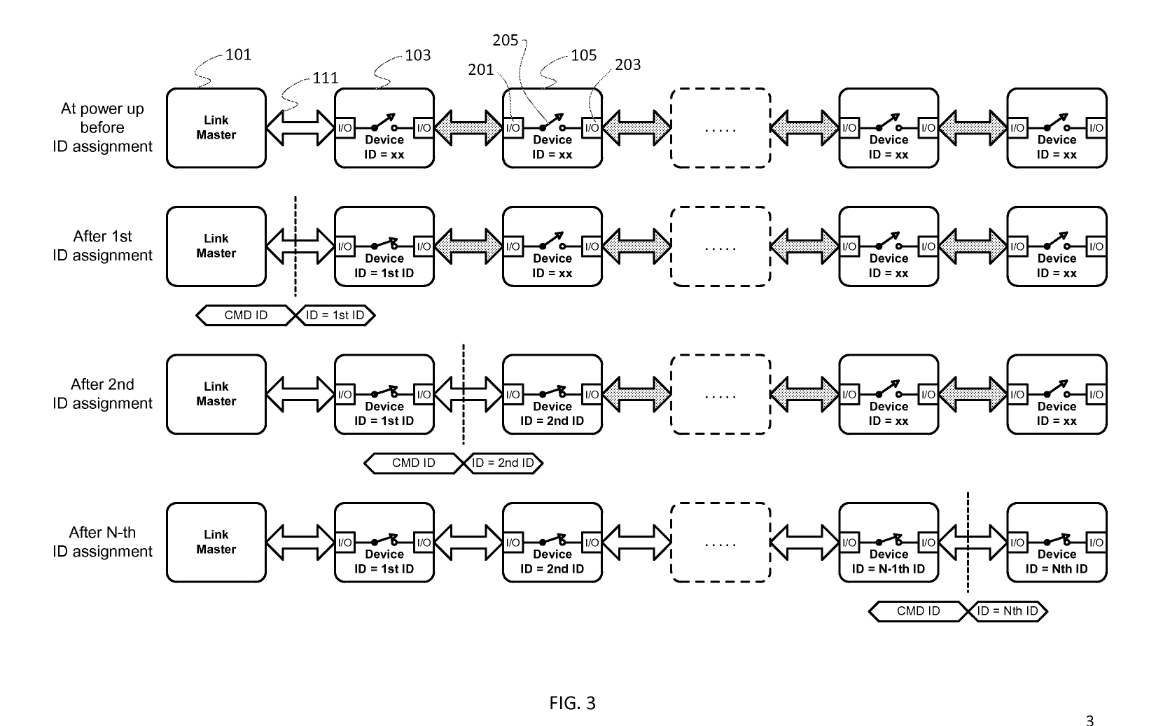

FIG. 3 illustrates the process of device ID assignment for the system depicted in FIG. 1. Referring to FIG. 3, at system power-up before device ID assignment, all devices do not have ID and the connection switches 205 are in OFF position. In other words, the two I/O ports 201 and 203 within each device are disconnected. The link master 101 is configured to write a sequence of ID assignment commands through the communication link 111.

Referring to FIG. 3, each device will execute the 1st ID assignment command by saving the ID number into the ID register; and turning the connection switch 205 to ON position. After the device is assigned with an ID, each device is configured not to react to any further ID assignment commands Finally, each device connected to the communication link gets a unique ID.

Referring to FIG. 1, after the link master 101 has assigned ID to all devices, all connection switches 205 are in the ON position. Electrically, the switches form a shared bus. The link master 101 is configured to then communicate to any device directly rather than going through each node (device) in a daisy chain manner.

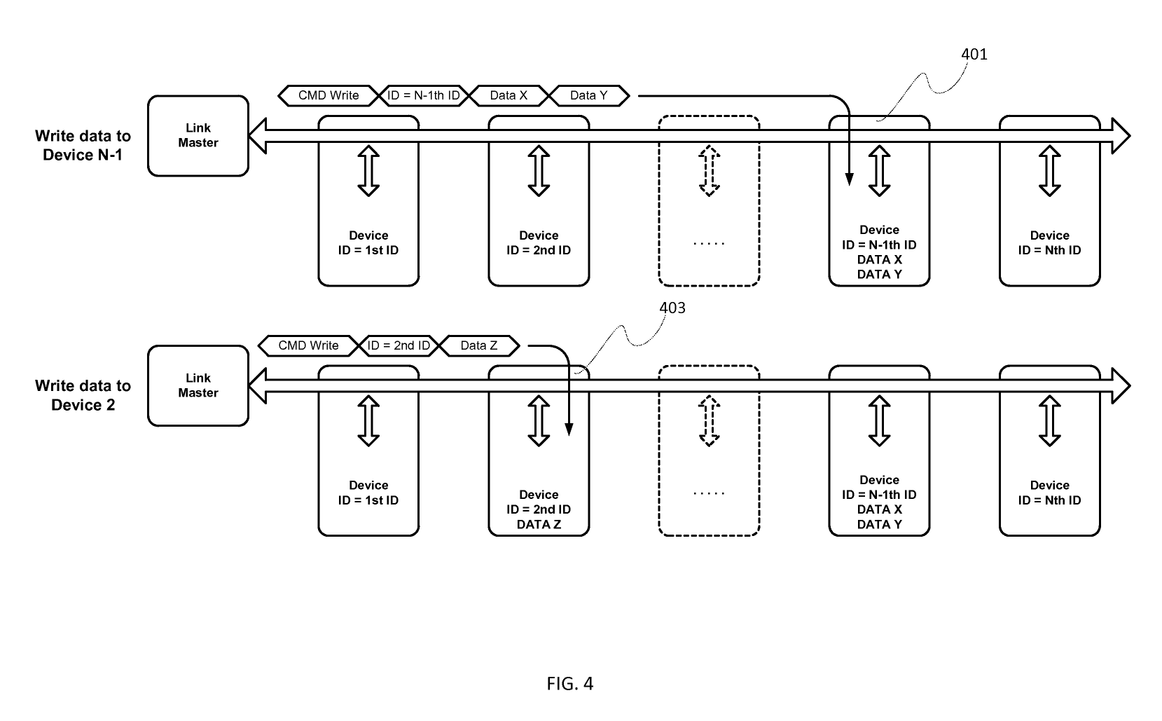

FIG. 4 illustrates a write process for the system depicted in FIG. 1. Referring to FIG. 4, when the link master 101 writes information to a specific device, the link master 101 sends out a WRITE command, a device ID and data. Only the targeted device (device 401 and device 403 in FIG. 4) will store the input data from the link master 101.

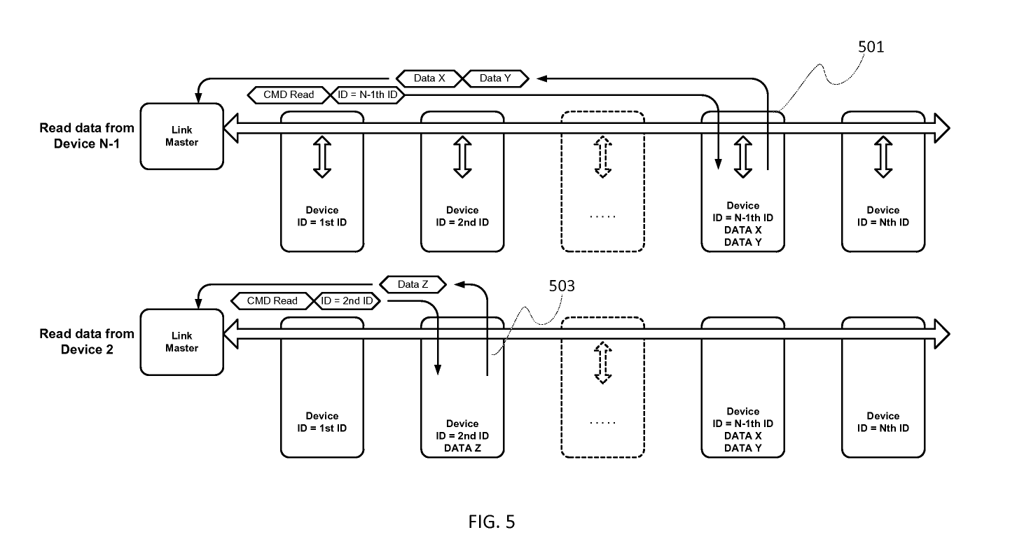

FIG. 5 illustrates a read process for the system depicted in FIG. 1. Referring to FIG. 5, when the link master 101 reads information from a specific device, the link master 101 sends out a READ command and a device ID. Only the targeted device (device 501 and device 503 in FIG. 5) will output data to the link master 101.

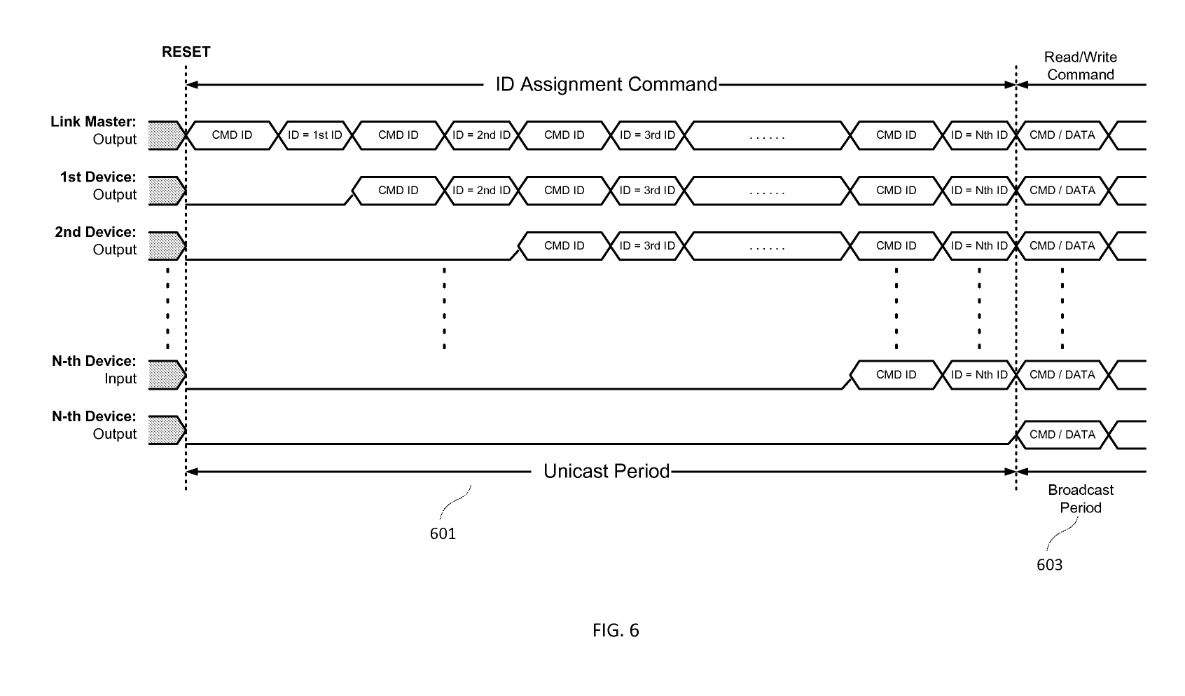

FIG. 6 is a timing diagram illustrating an ID assignment process for the system depicted in FIG. 1. Referring to FIG. 6, in a unicast period 601, ID assignment commands are passed to the devices one after another. The system enters unicast period 601 after system power-up or system reset. In a broadcast period 603, read or write commands are sent to a particular device directly without being passed by any of the other devices.

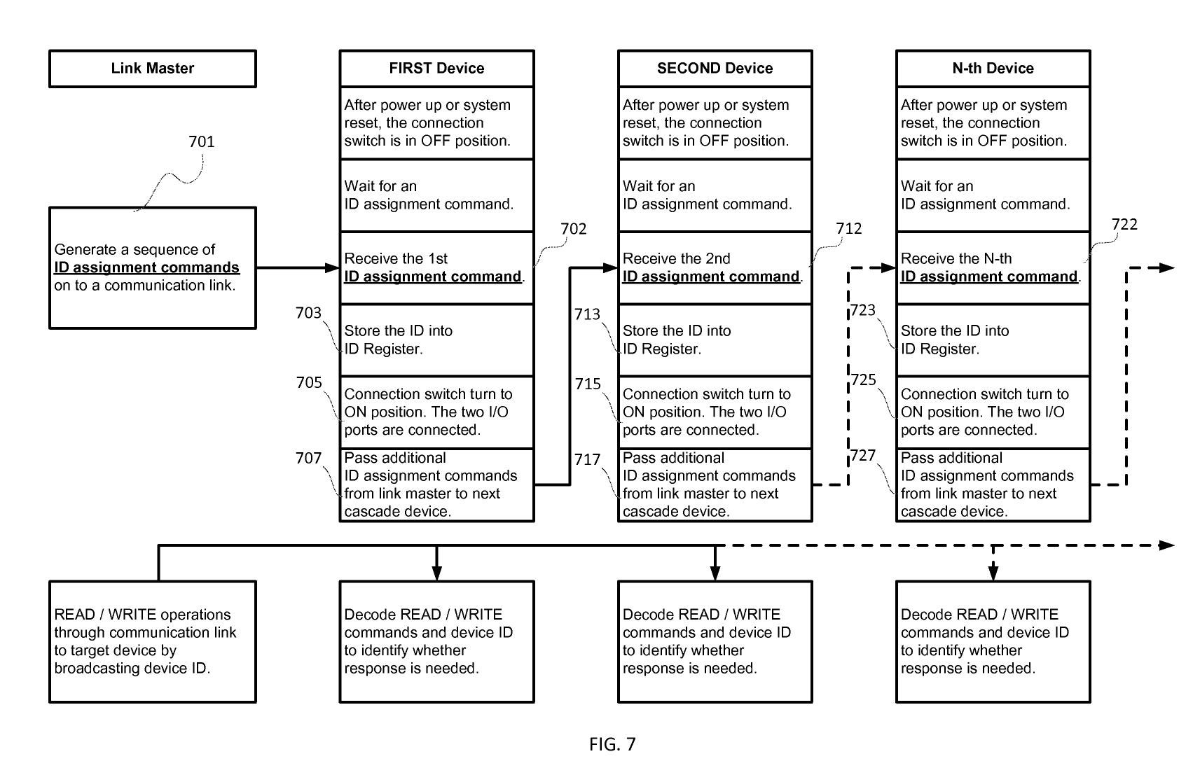

FIG. 7 illustrates a process flow of a method for communicating with a plurality of serially connected devices in accordance with the embodiment of FIG. 6. Referring to FIG. 7, when the link master generates a sequence of ID assignment commands on to a communication link (step 701), the first device receives a first ID assignment command in the sequence from the communication link (step 702), and stores the ID from the first ID assignment command into the ID register (step 703). The connection switch is then turned to an ON position and the two I/O ports are connected (step 705). After that, the first device passes additional ID assignment commands in the sequence to a second device, which is next to and serially connected to the first device (step 707).

The second device receives a second ID assignment command (step 712), and stores the ID into the ID register (step 713). The connection switch is then turned to an ON position and the two I/O ports are connected (step 715). After that, the second device passes addition ID assignment commands from the link master to a third device, which is next to and serially connected to the second device (step 717).

So the additional ID assignment commands are passed on in the above-mentioned way. The n-th device receives an n-th ID assignment command (step 722), and stores the ID into the ID register (step 723). The connection switch is then turned to an ON position and the two I/O ports are connected (step 725). After that, the n-th device passes addition ID assignment commands from the link master to a next device, which is serially connected to the n-th device (step 727).

It is noted that in the embodiment illustrated by FIG. 6 and FIG. 7, the switches 205 are turned off (open) at the system power-up.

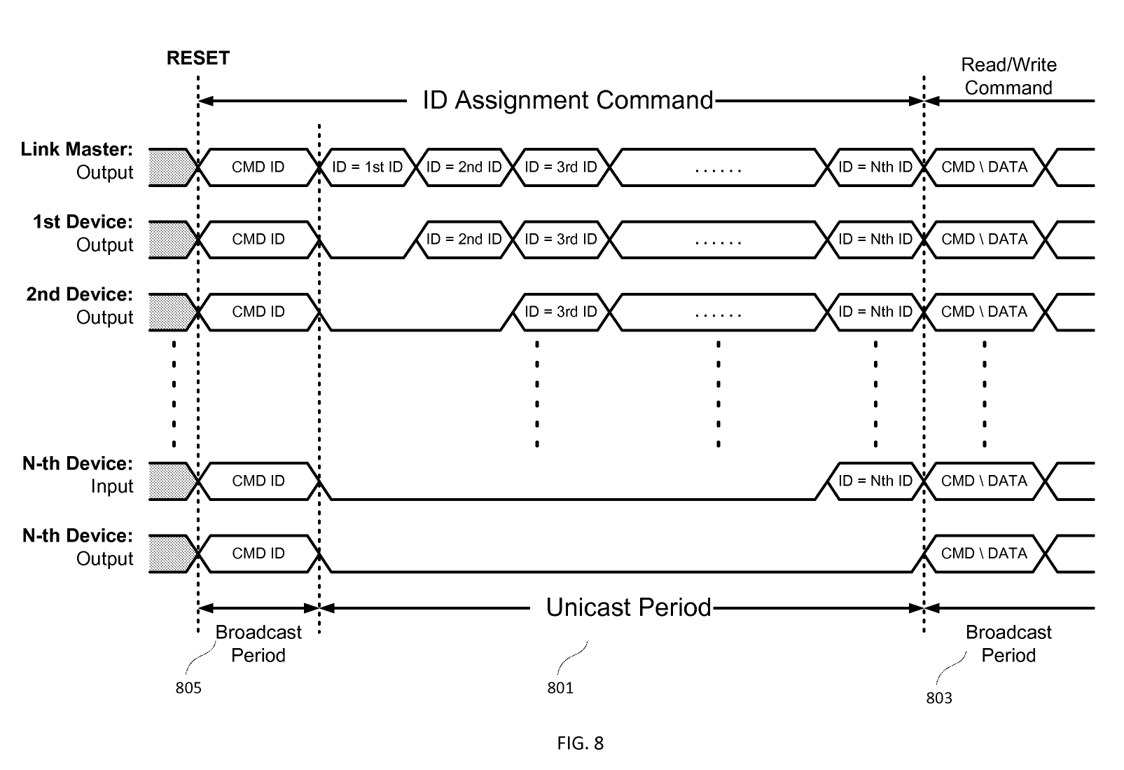

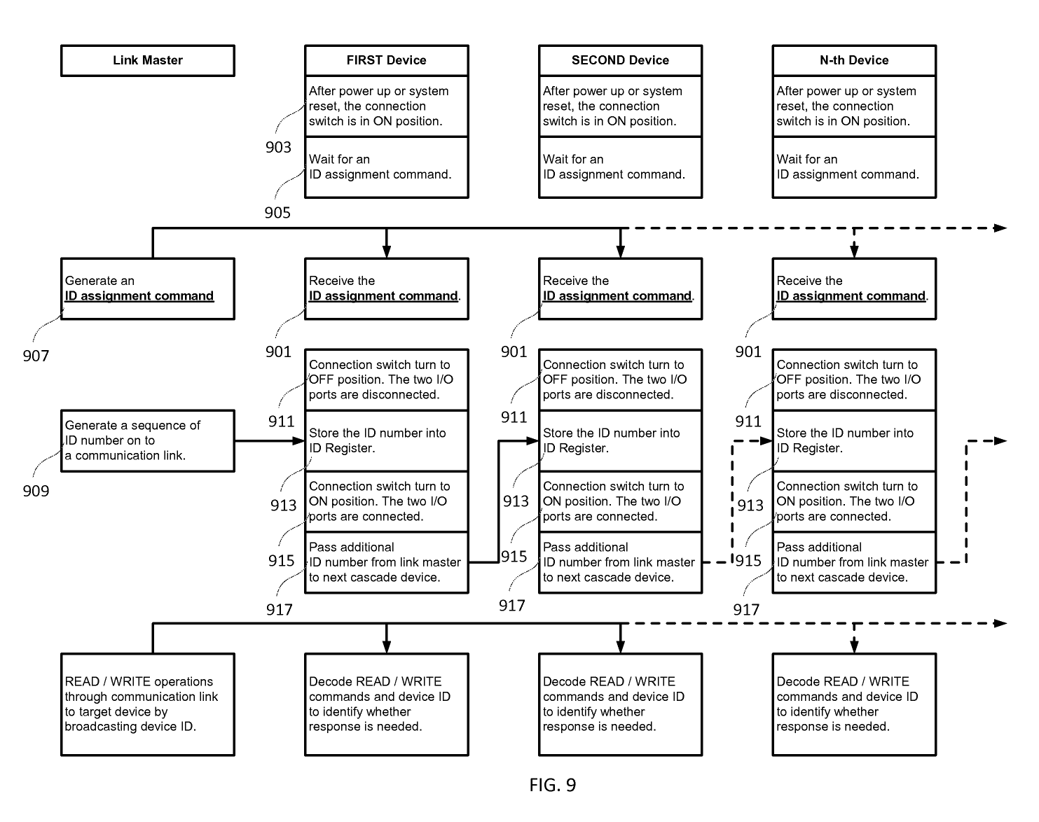

FIG. 8 is a timing diagram illustrating an ID assignment process for a system in accordance with another embodiment of the present patent application. In this embodiment, at system power-up or system reset, the connection switches 205 for all devices are turned on. Referring to FIG. 8, comparing to the embodiment illustrated in FIG. 6, before the unicast period 801, there is a broadcast period wherein the link master sends an ID assignment command to the devices in a broadcast manner (referring to step 901 in FIG. 9).

FIG. 9 illustrates a process flow of a method for communicating with a plurality of serially connected devices in accordance with the embodiment of FIG. 8. Referring to FIG. 9, at system power-up or system reset, the connection switches 205 for all devices are in an ON position (step 903), and the devices are waiting for an ID assignment command (step 905). The link master then generates an ID assignment command (step 907), and all the devices receive the ID assignment command (step 901). It is noted that this ID assignment command is sent and received in a broadcast manner.

The link master is configured to then generate a sequence of ID numbers onto a communication link (step 909). This sequence of ID numbers are communicated to the devices in a unicast manner. Comparing to the embodiment of FIG. 7, when the sequence is passed to each device, the switch in that device is turned off first so that the two I/O ports are disconnected (step 911). Then the device is configured to store an ID number in the sequence into its ID register (step 913), and then turn on the switch so that the two I/O ports are connected (step 915). After that the device is configured to pass additional ID numbers to the next serially connected device (step 917).

In another embodiment, for long distance applications, the bidirectional I/O ports in the above embodiments are replaced by unidirectional input or output ports. The reason is that high-impedance state (Hi-Z) in long distance communication is not safe. The communication link voltage level can be easily fluctuated (i.e. swing, rise or fall) by environment noise coupling. Hence, every link has to be driven by a voltage source.

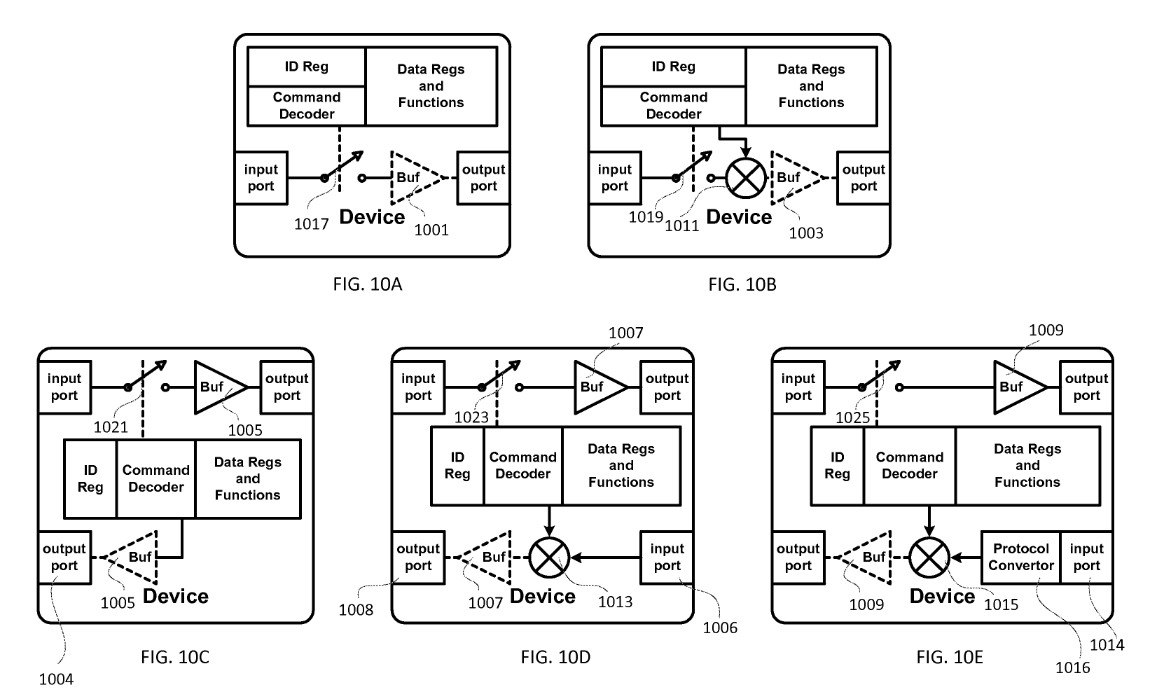

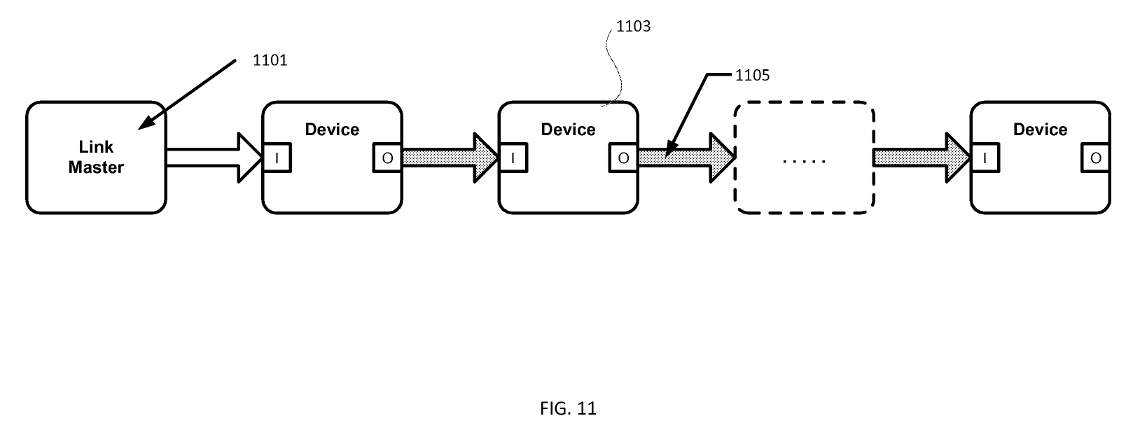

FIGS. 10A-10E illustrate a plurality of devices that can be connected serially in a system in accordance with various alternative embodiments depicted in FIG. 11 to FIG. 15. Referring to FIGS. 10A-10E, the device includes a minimum of two primary ports. One primary port serves as an input while the other primary port serves as an output. Data/information can be transferred from left to right (in a downstream direction). Alternatively, the device may include more than two ports. Data/information can be transferred from either left to right (in a downstream direction) or right to left (in an upstream direction).

Referring to FIGS. 10A and 10B, in these embodiments, the device includes a voltage buffer (1001 in FIG. 10A or 1003 in FIG. 10B) that is configured to strengthen signal from the input port to the output port. Signal buffering allows devices to be placed far apart without degradation of signal quality.

Alternatively, referring to FIGS. 10C, 10D and 10E, in these embodiments, the device includes an extra voltage buffer (1005 in FIG. 10C, 1007 in FIG. 10D, or 1009 in FIG. 10E) that is configured to strengthen signals running in both downstream and upstream directions. Referring to FIG. 10B, FIG. 10D and FIG. 10E, the device may further include a signal mixer or multiplexer (1011 in FIG. 10B, 1013 in FIG. 10D or 1015 in FIG. 10E) that allows sending back information from the device to the link master for systems that need such a facility.

Similar to previous embodiments, referring to FIGS. 10A-10E, the device includes a switch (1017, 1019, 1021, 1023, or 1025) that is configured to connect or disconnect the two primary ports. The device may further include a command decoder configured to recognize different commands and act accordingly. Actions include making or breaking the connection between the two primary ports. The device may further include an ID register configured to store the IDs being assigned by a link master.

FIG. 11 illustrates a system using the device depicted in FIG. 10A. Referring to FIG. 10A, in this embodiment, the device further includes a voltage buffer 1001 connecting the switch 1017 and the output port. Referring to FIG. 11, the link master 1101, and the devices 1103 are connected in series and communication links 1105 are established between the link master 1101 and the devices 1103 and among the devices 1103. This is a downstream only arrangement in which data is transmitted in a single direction from the link master 1101 to the various devices 1103.

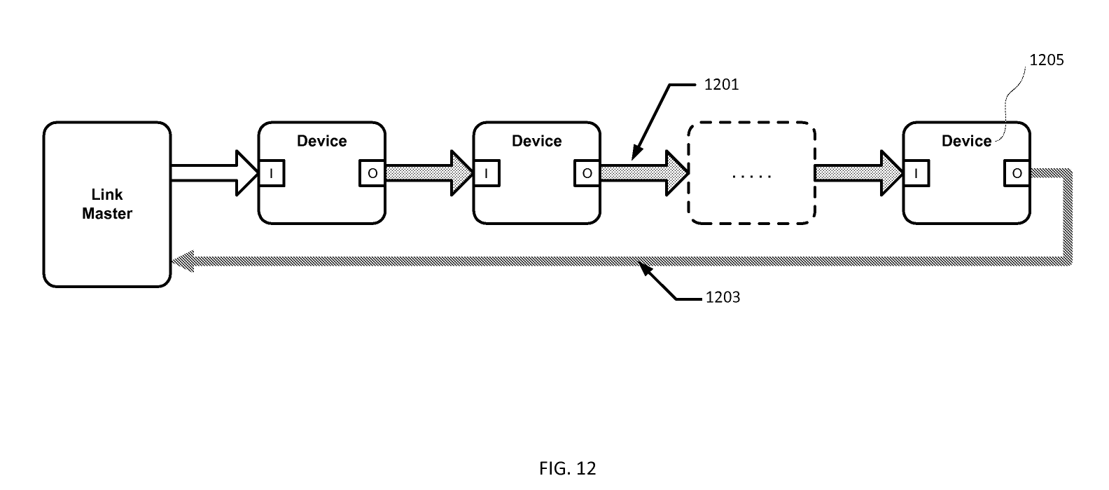

FIG. 12 illustrates a system using the device depicted in FIG. 10B. Referring to FIG. 10B, in this embodiment, the device further includes a mixer or multiplexer 1011 connecting the switch 1019 and the voltage buffer 1003. Referring to FIG. 12, compared with the embodiment illustrated by FIG. 11, besides the downstream links 1201, the system further includes an upstream link 1203 connecting the output port of the last device 1205 to the link master. Data is transmitted in a single direction through the devices. Upstream data are inserted into the unidirectional links by the multiplexers in the devices.

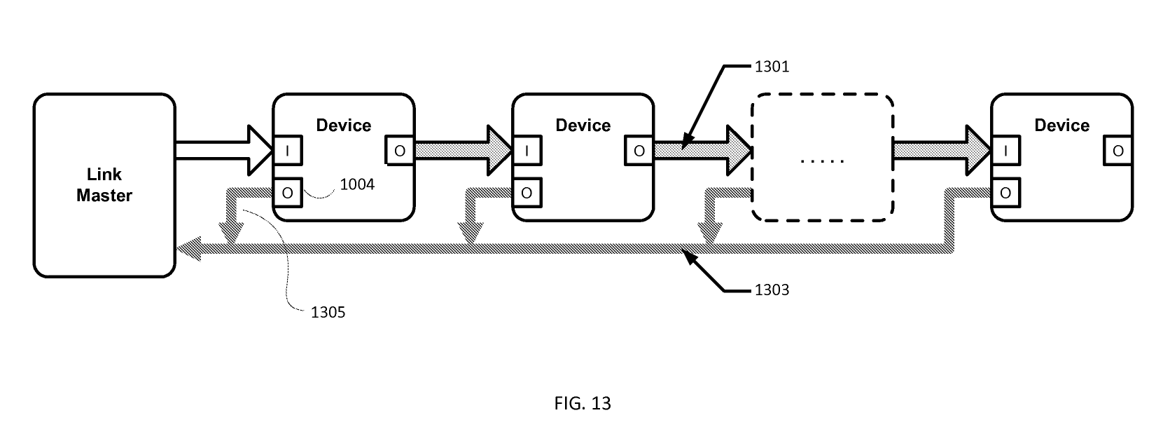

FIG. 13 illustrates a system using the device depicted in FIG. 10C. Referring to FIG. 10C, in this embodiment, the device includes a second output port 1004. This output port 1004 is connected with the command decoder and configured to be connected with an upstream link for upstream data communication. Referring to FIG. 13, compared with the embodiment in FIG. 11, besides the downstream links 1301, there is an additional communication link 1305 between the second output port 1004 of each device and the upstream link 1303. Communication link 1305 and upstream link 1303 are electrically the same group of wires. In other words, the links are connected in parallel physically in the upstream direction. In this embodiment, the link master is configured to assign ID to each one of the devices in sequence, and to access any one of the devices directly for read or write by providing the assigned ID to all devices in parallel.

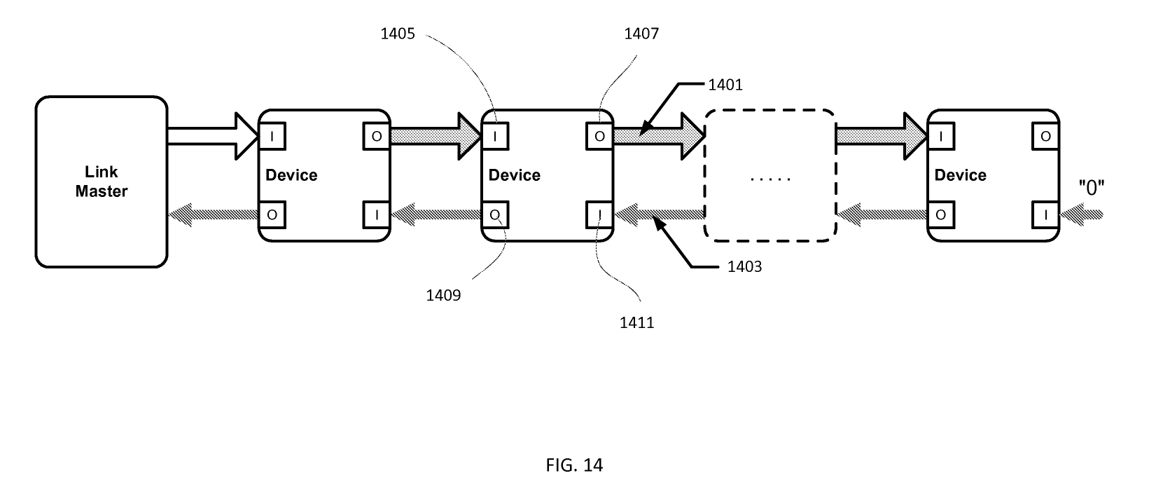

FIG. 14 illustrates a system using the device depicted in FIG. 10D. Referring to FIG. 10D, in this embodiment, the device includes a second input port 1006, a second output port 1008, a mixer 1013 connected with the second input port 1006 and the command decoder, and an optional buffer 1007 connecting the mixer 1013 and the second output port 1008.

Referring to FIG. 14, the first output port 1407 of one device is in communication with the first input port 1405 of another device next to that device, forming a downstream link 1401. The second output port 1409 of one device is in communication with the second input port 1411 of another device next to that device, forming an upstream link 1403. In this embodiment, upstream data and the downstream data can be transmitted simultaneously forming a full duplex arrangement. In contrast, the embodiment illustrated by FIG. 12 is a half-duplex arrangement.

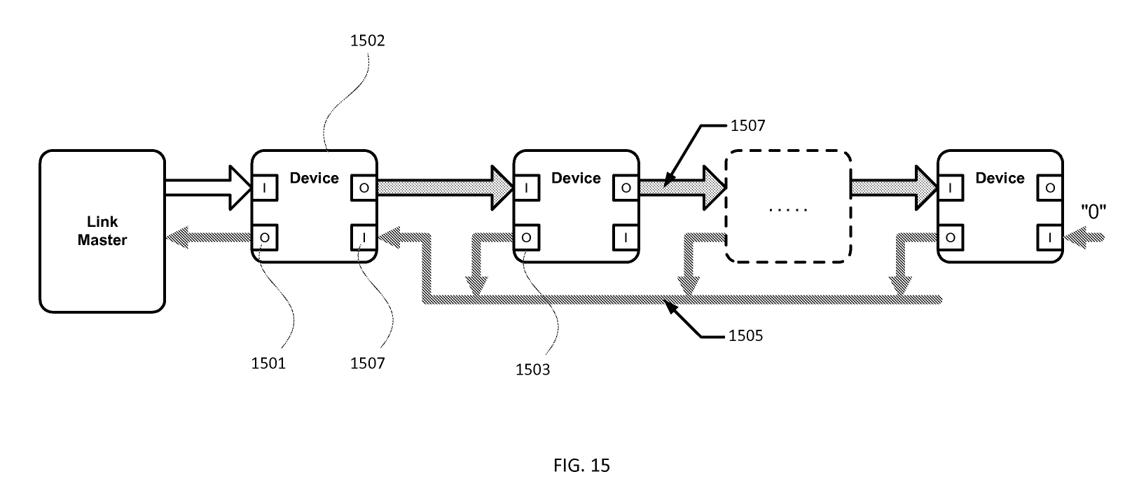

FIG. 15 illustrates a system using the device depicted in FIG. 10E. Referring to FIG. 10E, when compared with FIG. 10D, the device further includes a protocol converter 1016 connected between the second input port 1014 and the mixer 1015. Referring to FIG. 15, the second output port 1501 of the first device 1502 is connected with the link master. The second output ports 1503 of the other devices are connected to an upstream link 1505. The upstream link 1505 is connected to the second input port 1507 of the first device 1502. FIG. 15 illustrates a system which is similar to FIG. 13. Unlike the embodiment in FIG. 13, the link master, in FIG. 15, does not need to handle a bus protocol of which the upstream links are connected in parallel physically.

In all the above embodiments, serially connected devices do not need to have pre-programmed device IDs. A link master (typically implemented by a microcontroller) is configured to initialize all serial connected devices at system power up. All serially connected devices then have their unique ID assigned. The link master is configured to write information to specific devices through a communication link in a broadcast manner rather than in a daisy chain manner (or unicast manner). The link master is further configured to read information from specific devices through the communication link in a broadcast manner rather than in a daisy chain manner (or unicast manner).

In all the above embodiments, neither non-volatile memory, PCB hardwired connection nor any ID predefine technique is needed to distinguish devices connected in a sequence. To achieve some special read/write function requirement, the first device, the last device, or both the first and the last device can add hardware, pin connection or internal fuse switch difference to extend the function. There are both unicast and broadcast communication mode coexisting in the system. Unicast mode will be used to assign specific devices' IDs, addresses or both. Broadcast mode is used to read/write each specific device in the chain.

While the present patent application has been shown and described with particular references to a number of embodiments thereof, it should be noted that various other changes or modifications may be made without departing from the scope of the present invention.

What is claimed is:

1. A system for communicating with a plurality of serially connected devices, the system comprising:
a link master connected with one of the devices;
a plurality of devices serially connected with one another, each device comprising:
a first input port;
a first output port;
a switch connecting the first input port and the first output port; and
a command decoder connected with the switch and configured to recognize different commands from the link master and close or open the switch accordingly; and
an ID register configured to store the ID being assigned by a link master; wherein:
the link master is configured to assign ID to each one of the devices in sequence, and to access any one of the devices directly for read or write by providing the assigned ID to all devices in parallel.

2. The system of claim 1, wherein the link master is configured to generate a sequence of ID assignment commands onto a communication link, and a first device among the devices is configured to receive a first ID assignment command in the sequence from the communication link, store a first ID from the first ID assignment command into the ID register of the first device, close the switch of the first device, and pass additional ID assignment commands in the sequence to a next device serially connected to the first device.

3. The system of claim 1, wherein the link master is configured to generate an ID assignment command; all the devices are configured to receive the ID assignment command; all the switches inside all the devices are configured to open thereafter; the link master is configured to generate a sequence of ID numbers; a first device among the devices is configured to recognize a first ID number, store this first ID number in the sequence into the ID register of the first device, close the switch of the first device, and pass additional ID numbers in the sequence to a next device serially connected to the first device.

4. The system of claim 1, wherein each device further comprises a voltage buffer connecting the switch and the first output port.

5. The system of claim 4, wherein each device further comprises a mixer or multiplexer connecting the switch and the voltage buffer.

6. The system of claim 1, wherein each device further comprises a second output port, the second output port being connected with the command decoder and in communication with the link master though an upstream link.

7. The system of claim 1, wherein each device further comprises a second input port, a second output port, a mixer connected with the second input port and the command decoder, and a voltage buffer connecting the mixer and the second output port.

8. The system of claim 7, wherein the first output port of a first device among the devices is in communication with the first input port of a second device among the devices that is next to the first device, forming a downstream link, while the second output port of the second device is in communication with the second input port of a first device among the devices that is next to the second device, forming an upstream link.

9. The system of claim 7, wherein each device further comprises a protocol converter connected between the second input port and the mixer, the second output port of a first device among the devices is connected with the link master, the second output ports of the other devices are connected to an upstream link, while the upstream link is connected to the second input port of the first device.

10. A method for communicating with a plurality of serially connected devices, the method comprising:
assigning ID to each one of a plurality of devices one after another, each device comprising:
a first input port;
a first output port; and
a switch connecting the first input port and the first output port;
closing the switches of all the devices after assigning ID to the devices; and
reading or writing an individual one of the devices directly through the closed switches by the ID assigned to that device without reading or writing any other one of the devices.

11. The method of claim 10, wherein each device further comprises a command decoder connected with the switch and configured to recognize different commands from the link master and close or open the switch accordingly.

12. The method of claim 10, wherein each device further comprises an ID register configured to store the ID being assigned by the link master.

13. The method of claim 12 further comprising a link master generating a sequence of ID assignment commands onto a communication link; and a first device receiving a first ID assignment command in the sequence from the communication link, storing a first ID from the first ID assignment command into the ID register of the first device, closing the switch of the first device, and passing additional ID assignment commands in the sequence to a next device serially connected to the first device.

14. The method of claim 12 further comprising a link master generating an ID assignment command; all the devices receiving the ID assignment command; all the devices opening their switches thereafter; the link master generating a sequence of ID numbers; and a first device among the devices storing a first ID number in the sequence into the ID register of the first device, closing the switch of the first device, and passing additional ID numbers in the sequence to a next device serially connected to the first device.

15. The method of claim 10, wherein each device further comprises a voltage buffer connecting the switch and the first output port.

16. The method of claim 15, wherein each device further comprises a mixer or multiplexer connecting the switch and the voltage buffer.

17. A system for communicating with a plurality of serially connected devices, the system comprising:
a plurality of devices serially connected with one another and forming a chain, each device comprising:
a first input port;
a first output port;
a switch connecting the first input port and the first output port;
a voltage buffer connecting the switch and the first output port; and
a mixer or multiplexer connecting the switch and the voltage buffer; and
a link master connected with a first device and a last device in the chain; wherein:
the link master is configured to sequentially assign ID to each one of the devices one after another, close the switches of all the devices, and then read or write an individual one of the devices directly through the closed switches by the ID assigned to that device without reading or writing any other one of the devices.

18. The system of claim 17, wherein the first output port of the last device in the chain is connected to the link master through an upstream link.

19. The system of claim 17, wherein each device further comprises a command decoder connected with the switch and configured to recognize different commands from the link master and close or open the switch accordingly.

20. The system of claim 17, wherein each device further comprises an ID register configured to store the ID being assigned by the link master.
